(19) United States
(12) Patent Application Publication
(10) Pub. No.: US 2017/0353962 A1
(43) Pub. Date: Dec. 7, 2017

(54) METHOD AND APPARATUS FOR REDUCING INTERFERENCE BETWEEN WIFI AND LTE

(71) Applicant: Huawei Technologies Co., Ltd., Shenzhen (CN)

(72) Inventor: Weiai Gao, Shanghai (CN)

(21) Appl. No.: 15/538,606

(22) PCT Filed: Dec. 22, 2014
(86) PCT No.: PCT/CN2014/094565

§ 371 Date: Jun. 21, 2017

(51) Int. Cl. H04W 72/08; H04W 24/02; H04W 16/14; H04W 84/04; H04W 84/12

(52) U.S. Cl. CPC H04W 72/082; H04W 24/02; H04W 16/14; H04W 84/12; H04W 84/042

(57) ABSTRACT

A method and an apparatus for reducing interference between WiFi and LTE, so as to adjust a WiFi operating channel of a terminal according to an operating status of LTE, so that when WiFi and LTE coexist, the interference is minimized, and user experience is improved. The method includes: determining whether an LTE network is operating; obtaining an operating status of the LTE network if the LTE network is operating, where the operating status of the LTE network includes an operating frequency of the LTE network; and determining a WiFi operating channel according to the operating status of the LTE network and a preset rule, where the preset rule includes a correspondence between the operating status of the LTE network and a channel interference parameter between the LTE network and a WiFi channel.

### TECHNICAL FIELD

The present invention relates to the field of communications technologies, and in particular, to a method and an apparatus for reducing interference between WiFi and LTE.

### BACKGROUND

LTE (Long Term Evolution, Long Term Evolution) is Long Term Evolution of UMTS technical standards formulated by the 3GPP (The Third Generation Partnership Project, 3rd Generation Partnership Project) organization. LTE includes two modes: TDD (Time Division Duplexing, time division duplex) and FDD (Frequency Division Duplexing, frequency division duplex). Frequency bands that can be supported by TDD-LTE include frequency bands such as B38 (2750 MHz to 2620 MHz), B39 (1880 MHz to 1920 MHz), B40 (2300 MHz to 2400 MHz), B41 (2490 MHz to 2690 MHz), and frequency bands that can be supported by FDD-LTE include B7 and other frequency bands. An uplink frequency band (uplink) of the frequency band B7 is 2500 MHz to 2570 MHz, and a downlink frequency band (downlink) of the frequency band B7 is 2620 MHz to 2690 MHz.

WiFi (Wireless Fidelity, Wireless Fidelity) is a technology that can enable terminals (such as a personal computer, a mobile phone and a Pad) to be connected to each other in a wireless manner, and is used for improving interoperability between wireless network products based on the IEEE 802.11 standards. An operating frequency range of WiFi is 2400 MHz to 2483.5 MHz, and is divided into 13 WiFi channels (Channel 1 to Channel 13), and each WiFi channel has a bandwidth of 22 MHz.

FIG. 1 is a schematic diagram of an operating frequency band of LTE and an operating frequency band of WiFi. It can be seen from the figure that there is no interval between a low frequency of WiFi and a high frequency of LTE B40, and an interval between a high frequency of WiFi and a low frequency of LTE B41 is approximately 13 MHz. In the prior art, when WiFi and LTE of a terminal coexist in operation, the terminal is connected to a base station by means of LTE, and then enables a WiFi hotspot function. However, according to different terminal products, a channel in which a WiFi hotspot is enabled to operate is fixed. Therefore, when WiFi and LTE coexist, interference can be easily generated between radio frequency signals of WiFi and LTE.

### SUMMARY

Embodiments of the present invention provide a method and an apparatus for reducing interference between WiFi and LTE, so as to adjust a WiFi operating channel of a terminal according to an operating status of LTE, so that when WiFi and LTE coexist, the interference is minimized, and user experience is improved.

To achieve the foregoing objectives, the following technical solutions are used in the embodiments of the present invention.

According to a first aspect, an embodiment of the present invention provides a method for reducing interference between WiFi and LTE, including:

determining whether an LTE network is operating;

obtaining an operating status of the LTE network if the LTE network is operating, where the operating status of the LTE network includes an operating frequency of the LTE network; and

determining a WiFi operating channel according to the operating status of the LTE network and a preset rule, where the preset rule includes a correspondence between the operating status of the LTE network and a channel interference parameter between the LTE network and a WiFi channel.

In a first possible implementation manner of the first aspect, when the channel interference parameter is a channel interference value, the determining a WiFi operating channel according to the operating status of the LTE network and a preset rule includes:

determining a first WiFi channel according to the operating status of the LTE network and the preset rule, where the first WiFi channel is a WiFi channel that has a channel interference value less than a first threshold; and

selecting any unoccupied channel in the first WiFi channel as the WiFi operating channel.

In a second possible implementation manner of the first aspect, when the channel interference parameter is a throughput, the determining a WiFi operating channel according to the operating status of the LTE network and a preset rule includes:

determining a second WiFi channel according to the operating status of the LTE network and the preset rule, where the second WiFi channel is a WiFi channel that has a throughput greater than or equal to a second threshold; and

selecting any unoccupied channel in the second WiFi channel as the WiFi operating channel.

In any one of the first aspect or the first two possible implementation manners of the first aspect, a third possible implementation manner of the first aspect is further provided, where before the determining whether an LTE network is operating, the method further includes: enabling a WiFi hotspot function.

In any one of the first aspect or the first three possible implementation manners of the first aspect, a fourth possible implementation manner of the first aspect is further provided, where the method further includes:

selecting any unoccupied channel in the WiFi channel as the WiFi operating channel if the LTE network is not operating.

According to a second aspect, an embodiment of the present invention provides an apparatus for reducing interference between WiFi and LTE, including:

a first determining unit, configured to determine whether an LTE network is operating;

an obtaining unit, configured to obtain an operating status of the LTE network when the first determining unit determines that the LTE network is operating, where the operating status of the LTE network includes an operating frequency of the LTE network; and

a second determining unit, configured to determine a WiFi operating channel according to the operating status of the LTE network that is obtained by the obtaining unit and a preset rule, where the preset rule includes a correspondence between the operating status of the LTE network and a channel interference parameter between the LTE network and a WiFi channel.

In a first possible implementation manner of the second aspect, the second determining unit includes a determining subunit and a selection subunit, where

the determining subunit is configured to: when the channel interference parameter is a channel interference value, determine a first WiFi channel according to the operating status of the LTE network and the preset rule, where the first WiFi channel is a WiFi channel that has a channel interference value less than a first threshold; and

the selection subunit is configured to select any unoccupied channel in the first WiFi channel as the WiFi operating channel.

In the second aspect or the first possible implementation manner of the second aspect, a second possible implementation manner of the second aspect is further provided, where the determining subunit is further configured to: when the channel interference parameter is a throughput, determine a second WiFi channel according to the operating status of the LTE network and the preset rule, where the second WiFi channel is a WiFi channel that has a throughput greater than or equal to a second threshold; and

the selection subunit is further configured to select any unoccupied channel in the second WiFi channel as the WiFi operating channel.

In any one of the second aspect or the first two possible implementation manners of the second aspect, a third possible implementation manner of the second aspect is further provided, where the apparatus further includes an enabling unit, where the enabling unit is configured to: before the first determining unit determines whether the LTE network is operating, enable a WiFi hotspot function.

In any one of the second aspect or the first three possible implementation manners of the second aspect, a fourth possible implementation manner of the second aspect is further provided, where the selection subunit is further configured to select any unoccupied channel in the WiFi channel as the WiFi operating channel if the LTE network is not operating.

According to the method and the apparatus for reducing interference between WiFi and LTE that are provided by the embodiments of the present invention, an operating status of an LTE network is detected, if the LTE network is in an operating status, an operating frequency of the LTE network is obtained, and a WiFi operating channel is determined according to a correspondence, between the operating status of the LTE network and a channel interference parameter between the LTE network and a WiFi operating channel, in a preset rule, so as to adjust a WiFi operating channel of a terminal according to an operating status of LTE, so that when WiFi and LTE coexist, the interference is minimized, and user experience is improved.

### BRIEF DESCRIPTION OF DRAWINGS

To describe the technical solutions in the embodiments of the present invention more clearly, the following briefly describes the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 is a schematic diagram of a frequency band of LTE and a frequency band of WiFi in the prior art;

FIG. 2 is a schematic diagram of a method for reducing interference between WiFi and LTE according to an embodiment of the present invention;

FIG. 3 is a schematic diagram of another method for reducing interference between WiFi and LTE according to an embodiment of the present invention;

FIG. 4 is a schematic diagram of an apparatus for reducing interference between WiFi and LTE according to an embodiment of the present invention;

FIG. 5 is a schematic diagram of another apparatus for reducing interference between WiFi and LTE according to an embodiment of the present invention; and

FIG. 6 is a schematic diagram of still another apparatus for reducing interference between WiFi and LTE according to an embodiment of the present invention.

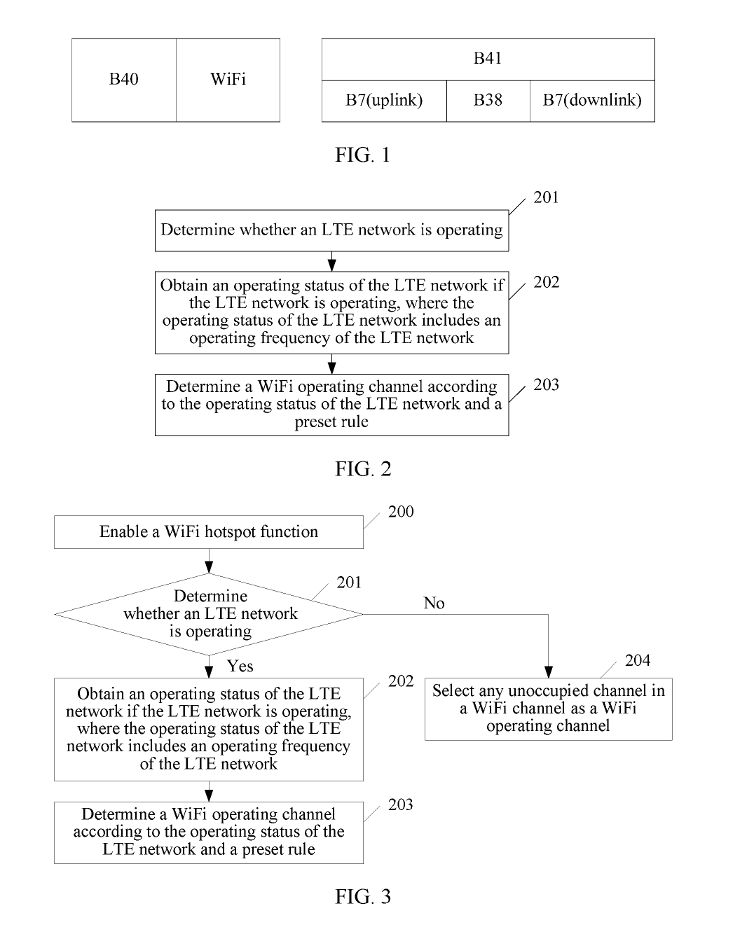

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by persons of ordinary skill in the art based on the embodiments of the present invention without creative efforts shall fall within the protection scope of the present invention.

### Embodiment 1

This embodiment of the present invention provides a method for reducing interference between WiFi and LTE. As shown in FIG. 2, the method includes:

Step 201: Determine whether an LTE network is operating.

Step 202: Obtain an operating status of the LTE network if the LTE network is operating, where the operating status of the LTE network includes an operating frequency of the LTE network.

Because LTE can support multiple different frequency bands, an operating status of a current LTE network, that is, an operating frequency of the current LTE network, needs to be obtained. An operating frequency band of the current LTE network can be determined according to the operating frequency. For example, if the LTE network is operating, the obtained operating frequency of the current LTE network is 2385 MHz, and it can be determined, according to the operating frequency of 2385 MHz, that the operating frequency band of the current LTE network is B40. Optionally, the operating frequency band and the operating frequency of the current LTE network may be obtained directly.

Step 203: Determine a WiFi operating channel according to the operating status of the LTE network and a preset rule, where the preset rule includes a correspondence between the operating status of the LTE network and a channel interference parameter between the LTE network and a WiFi channel.

The channel interference parameter includes, but is not limited to, a channel interference value, a throughput and the like.

Manner 1: When the channel interference parameter is a channel interference value, the determining a WiFi operating channel according to the operating status of the LTE network and a preset rule includes:

(a1): Determine a first WiFi channel according to the operating status of the LTE network and the preset rule. The first WiFi channel is a WiFi channel that has a channel interference value less than a first threshold.

TABLE 1

| | Frequency corresponding to LTE B40/a bandwidth of 20 M | | | | | | |
|---|---|---|---|---|---|---|---|
| WiFi | 2390 | 2385 | 2380 | 2375 | 2370 | 2365 | 2360 |
| Channel | MHz | MHz | MHz | MHz | MHz | MHz | MHz |
| Chan1 | 56 | 48 | 44 | 36 | 30 | 15 | 8 |
| Chan2 | 32 | 36 | 31 | 25 | 18 | 2 | 1 |
| Chan3 | 32 | 25 | 20 | 12 | 5 | 0 | 0 |
| Chan4 | 21 | 11 | 8 | 3 | 0 | 0 | 0 |
| Chan5 | 8 | 3 | 1 | 0 | 0 | 0 | 0 |
| Chan6 | 2 | 0 | 0 | 0 | 0 | 0 | 0 |
| Chan7 | 0 | 0 | 0 | 0 | 0 | 0 | 0 |
| Chan8 | 0 | 0 | 0 | 0 | 0 | 0 | 0 |
| Chan9 | 0 | 0 | 0 | 0 | 0 | 0 | 0 |
| Chan10 | 0 | 0 | 0 | 0 | 0 | 0 | 0 |
| Chan11 | 0 | 0 | 0 | 0 | 0 | 0 | 0 |
| Chan12 | 0 | 0 | 0 | 0 | 0 | 0 | 0 |
| Chan13 | 0 | 0 | 0 | 0 | 0 | 0 | 0 |

The preset rule may be shown in Table 1. The first row represents an operating frequency band and an operating frequency of an LTE network (in Table 1, descriptions are provided by using an example in which the operating frequency band of the LTE network is B40 and a bandwidth of the LTE network is 20 M), the first column represents WiFi channels (13 in total, marked as Chan1 to Chan13), and the second row represents each operating frequency in the operating frequency band shown in the first row (in Table 1, descriptions are provided by using an example in which the operating frequency ranges from 2360 MHz to 2390 MHz and every two operating frequencies have an interval of 5 MHz). Specifically, when the LTE network is operating at 2390 MHz, interference of the 2390 MHz channel in the frequency band LTE B40 to the WiFi channel Chan1 is 56 dB, and interference of the 2390 MHz channel in the frequency band LTE B40 to the WiFi channel Chan2 is 32 dB, and by analogy, interference of the 2390 MHz channel in the frequency band LTE B40 to the WiFi channel Chan13 is 0 dB. Generally, a channel interference parameter in Row M and Column N represents a channel interference value of a given WiFi channel in a case of an operating frequency band and an operating frequency of a current LTE network (the channel interference value may be represented by dB). It should be noted that Table 1 is only an exemplary description of the preset rule, and any other manners that can represent the preset rule all fall within the protection scope of the present invention. Moreover, for different terminal devices, specific values in Table 1 may be set according to an actual test and measurement.

As shown in Table 1, when the LTE network is operating in the frequency band LTE B40 and has a bandwidth of 20 M and an operating frequency of 2390 MHz, channel interference values of the WiFi channels decrease gradually from Chan1 to Chan13. Therefore, a WiFi channel that has a channel interference value less than a first threshold may be used as the first WiFi channel. In this case, interference between the first WiFi channel and the operating status of the current LTE network is relatively small. As shown in Table 1, assuming that the first threshold is 0 dB, the first WiFi channel includes Chan7 to Chan13.

(a2): Select any unoccupied channel in the first WiFi channel as the WiFi operating channel.

According to descriptions in (a1), if Chan7 to Chan13 are selected as first WiFi channels, any unoccupied channel in Chan7 to Chan13 is selected as a WiFi operating channel. For example, when Chan7 is already occupied, a channel conflict will occur if Chan7 is selected at this time. Therefore, any unoccupied WiFi channel in Chan8 to Chan13 may be selected as the WiFi operating channel.

Manner 2: When the channel interference parameter is a throughput, the determining a WiFi operating channel according to the operating status of the LTE network and a preset rule includes:

(b1): Determine a second WiFi channel according to the operating status of the LTE network and the preset rule, where the second WiFi channel is a WiFi channel that has a throughput greater than or equal to a second threshold.

TABLE 2

| | Frequency corresponding to LTE B40/a bandwidth of 20 M | | | | | | |
|---|---|---|---|---|---|---|---|
| WiFi | 2390 | 2385 | 2380 | 2375 | 2370 | 2365 | 2360 |
| Channel | MHz | MHz | MHz | MHz | MHz | MHz | MHz |
| Chan1 | 0 | 0 | 1.5 | 8.2 | 31 | 45.2 | 47.6 |
| Chan2 | 0 | 0 | 2.8 | 10.3 | 35 | 45.8 | 48.2 |
| Chan3 | 0 | 6 | 14 | 25 | 46 | 54 | 54 |
| Chan4 | 2.5 | 16 | 25 | 36 | 54 | 54 | 54 |
| Chan5 | 12 | 32 | 38 | 54 | 54 | 54 | 54 |
| Chan6 | 38 | 54 | 54 | 54 | 54 | 54 | 54 |
| Chan7 | 54 | 54 | 54 | 54 | 54 | 54 | 54 |
| Chan8 | 54 | 54 | 54 | 54 | 54 | 54 | 54 |
| Chan9 | 54 | 54 | 54 | 54 | 54 | 54 | 54 |
| Chan10 | 54 | 54 | 54 | 54 | 54 | 54 | 54 |
| Chan11 | 54 | 54 | 54 | 54 | 54 | 54 | 54 |
| Chan12 | 54 | 54 | 54 | 54 | 54 | 54 | 54 |
| Chan13 | 54 | 54 | 54 | 54 | 54 | 54 | 54 |

The preset rule may be shown in Table 2. The first row represents an operating frequency band and an operating frequency of an LTE network (in Table 2, descriptions are provided by using an example in which the operating frequency band of the LTE network is B40 and a bandwidth of the LTE network is 20 M), the first column represents WiFi channels (13 in total, marked as Chan1 to Chan13), and the second row represents each operating frequency in the operating frequency band shown in the first row (in Table 2, descriptions are provided by using an example in which the operating frequency ranges from 2360 MHz to 2390 MHz and every two operating frequencies have an interval of 5 MHz). Specifically, when the LTE network is operating at 2390 MHz, a throughput of the WiFi channel Chan1 is 0 Mbps, and a throughput of the WiFi channel Chan2 is 0 Mbps, and by analogy, a throughput of the WiFi channel Chan13 is 54 Mbps. Generally, a throughput in Row M and Column N represents a throughput of a given WiFi channel in a case of an operating frequency band and an operating frequency of a current LTE network. It should be noted that Table 2 is only an exemplary description of the preset rule, and any other manners that can represent the preset rule all fall within the protection scope of the present invention. Moreover, for different terminal devices, specific values in Table 2 may be set according to an actual test and measurement.

As shown in Table 2, when the LTE network is operating in the frequency band LTE B40 and has a bandwidth of 20 M and an operating frequency of 2390 MHz, throughputs of the WiFi channels increase gradually from Chan1 to Chan13, the increase in the throughputs means a decrease in interference between two channels. Therefore, a WiFi channel that has a throughput greater than or equal to a second threshold may be used as a second WiFi channel. In this case, interference between the second WiFi channel and the operating status of the current LTE network is relatively small. As shown in Table 2, assuming that the second threshold is 54 dB, the second WiFi channel includes Chan7 to Chan13.

(b2): Select any unoccupied channel in the second WiFi channel as the WiFi operating channel.

According to descriptions in b1, if Chan7 to Chan13 are selected as second WiFi channels, any unoccupied channel in Chan7 to Chan13 is selected as a WiFi operating channel. For example, when Chan7 is already occupied, a channel conflict will occur if Chan7 is selected at this time. Therefore, any unoccupied WiFi channel in Chan8 to Chan13 may be selected as the WiFi operating channel.

Further, as shown in FIG. 3, before step 201, the method further includes:

Step 200: Enable a WiFi hotspot function.

As shown in FIG. 3, after step 201, the method may further include:

Step 204: Select any unoccupied channel in the WiFi channel as the WiFi operating channel when the LTE network is not operating.

Specifically, because the LTE network is not operating at this time, there is no problem of interference between the LTE network and the WiFi channel, so that any unoccupied channel in the WiFi channels (that is, Chan1 to Chan13) may be selected as the WiFi operating channel.

According to the method for reducing interference between WiFi and LTE that is provided by this embodiment of the present invention, an operating status of an LTE network is detected, if the LTE network is in an operating status, an operating frequency of the LTE network is obtained, and a WiFi operating channel is determined according to a correspondence, between the operating status of the LTE network and a channel interference parameter between the LTE network and a WiFi operating channel, in a preset rule, so as to adjust a WiFi operating channel of a terminal according to an operating status of LTE, so that when WiFi and LTE coexist, the interference is minimized, and user experience is improved.

### Embodiment 2

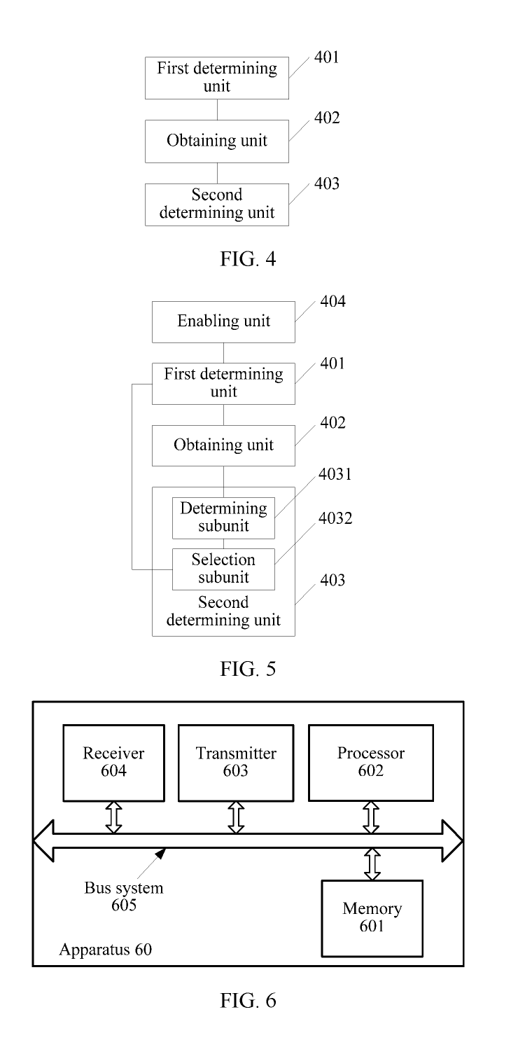

This embodiment of the present invention provides an apparatus for reducing interference between WiFi and LTE. The apparatus corresponds to the method for reducing interference between WiFi and LTE described in Embodiment 1. As shown in FIG. 4, the apparatus includes:

a first determining unit 401, configured to determine whether an LTE network is operating;

an obtaining unit 402, configured to obtain an operating status of the LTE network when the first determining unit 401 determines that the LTE network is operating, where the operating status of the LTE network includes an operating frequency of the LTE network; and

a second determining unit 403, configured to determine a WiFi operating channel according to the operating status of the LTE network and a preset rule obtained by the obtaining unit 402, where the preset rule includes a correspondence between the operating status of the LTE network and a channel interference parameter between the LTE network and a WiFi channel.

Optionally, as shown in FIG. 5, the second determining unit 403 includes a determining subunit 4031 and a selection subunit 4032, where

the determining subunit 4031 is configured to: when the channel interference parameter is a channel interference value, determine a first WiFi channel according to the operating status of the LTE network and the preset rule, where the first WiFi channel is a WiFi channel that has a channel interference value less than a first threshold; and

the selection subunit 4032 is configured to select any unoccupied channel in the first WiFi channel as the WiFi operating channel.

Optionally, as shown in FIG. 5, the determining subunit 4031 is further configured to: when the channel interference parameter is a throughput, determine a second WiFi channel according to the operating status of the LTE network and the preset rule, where the second WiFi channel is a WiFi channel that has a throughput greater than or equal to a second threshold; and

the selection subunit 4032 is further configured to select any unoccupied channel in the second WiFi channel as the WiFi operating channel.

Optionally, as shown in FIG. 5, this apparatus further includes an enabling unit 404, where the enabling unit 404 is configured to: before the first determining unit 401 determines whether the LTE network is operating, enable a WiFi hotspot function.

Optionally, as shown in FIG. 5, the selection subunit 4032 is further configured to select any unoccupied channel in the WiFi channel as the WiFi operating channel if the LTE network is not operating.

According to the apparatus for reducing interference between WiFi and LTE that is provided by this embodiment of the present invention, the first determining unit determines an operating status of an LTE network, and if it is determined that the LTE network is in an operating status, the second determining unit determines a WiFi operating channel according to an operating frequency of the LTE network that is obtained by the obtaining unit, and according to a correspondence, between the operating status of the LTE network and a channel interference parameter between the LTE network and a WiFi operating channel, in a preset rule, so as to adjust a WiFi operating channel of a terminal according to an operating status of LTE, so that when WiFi and LTE coexist, the interference is minimized, and user experience is improved.

### Embodiment 3

This embodiment of the present invention provides an apparatus for reducing interference between WiFi and LTE. As shown in FIG. 6, the apparatus 60 includes a memory 601, a processor 602, a transmitter 603 (optional), a receiver 604 (optional) and a bus system 605.

The memory 601 may include a read-only memory and a random access memory, and provides an instruction and data to the processor 602. A part of the memory 601 may further include a non-volatile random access memory (NVRAM).

The memory 601 stores the following elements, executable modules or data structures, or a subset thereof, or an extended set thereof:

operation instructions, including various operation instructions and used to perform various operations; and

an operating system, including various system programs and used to implement various basic services and process a hardware-based task.

In this embodiment of the present invention, the processor 602 invokes the operation instructions stored in the memory 601 to perform the following operations: determining whether an LTE network is operating; obtaining an operating status of the LTE network if the LTE network is operating, where the operating status of the LTE network includes an operating frequency of the LTE network; and determining a WiFi operating channel according to the operating status of the LTE network and a preset rule, where the preset rule includes a correspondence between the operating status of the LTE network and a channel interference parameter between the LTE network and a WiFi channel.

Optionally, the processor 602 is further configured to: when the channel interference parameter is a channel interference value, determine a first WiFi channel according to the operating status of the LTE network and the preset rule. The first WiFi channel is a WiFi channel that has a channel interference value less than a first threshold; and select any unoccupied channel in the first WiFi channel as the WiFi operating channel.

Optionally, the processor 602 is further configured to: when the channel interference parameter is a throughput, determine a second WiFi channel according to the operating status of the LTE network and the preset rule, where the second WiFi channel is a WiFi channel that has a throughput greater than or equal to a second threshold; and select any unoccupied channel in the second WiFi channel as the WiFi operating channel.

Optionally, the processor 602 is further configured to: before determining whether the LTE network is operating, enable a WiFi hotspot function.

Optionally, the processor 602 is further configured to select any unoccupied channel in the WiFi channel as the WiFi operating channel if the LTE network is not operating.

The processor 602 may be, for example, a CPU (Central Processing Unit, central processing unit). The memory 601 may include a read-only memory and a random access memory, and provides an instruction and data to the processor 602. A part of the memory 601 may further include a non-volatile random access memory (NVRAM). In specific application, components of the apparatus for reducing interference between WiFi and LTE are coupled together by using the bus system 605, where besides a data bus, the bus system 605 may further include a power bus, a control bus, a state signal bus, and the like. However, for clear description, various types of buses in the figure are marked as the bus system 605.

The method disclosed in the foregoing embodiment of the present invention may be applied to the processor 602, or be implemented by the processor 602. The processor 602 may be an integrated circuit chip and has a signal processing capability. In an implementation process, each step of the foregoing method may be implemented by a hardware integrated logic circuit in the processor 602 or by an instruction in a software form. The foregoing processor 602 may be a general purpose processor, a digital signal processor (DSP), an application-specific integrated circuit (ASIC), a field programmable gate array (FPGA), or another programmable logic device, discrete gate or transistor logic device, or discrete hardware component. The methods, steps, and logical block diagrams disclosed in the embodiments of the present invention may be implemented or performed. The general purpose processor may be a microprocessor or the processor 602 may be any conventional processor and the like. Steps of the methods disclosed with reference to the embodiments of the present invention may be directly performed and completed by means of a hardware decoding processor, or may be performed and completed by using a combination of hardware and software modules in a decoding processor. The software module may be located in a mature storage medium in the art, such as a random access memory, a flash memory, a read-only memory, a programmable read-only memory, an electrically-erasable programmable memory, or a register. The storage medium is located in the memory 601, and the processor 602 reads information in the memory 601 and completes the steps in the foregoing methods in combination with hardware of the processor 602.

According to the apparatus for reducing interference between WiFi and LTE that is provided by this embodiment of the present invention, an operating status of an LTE network is determined, and if it is determined that the LTE network is in an operating status, a WiFi operating channel is determined according to an operating frequency of the LTE network that is obtained by an obtaining unit, and according to a correspondence, between the operating status of the LTE network and a channel interference parameter between the LTE network and a WiFi operating channel, in a preset rule, so as to adjust a WiFi operating channel of a terminal according to an operating status of LTE, so that when WiFi and LTE coexist, the interference is minimized, and user experience is improved.

In the several embodiments provided in this application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) to perform some of the steps of the methods described in the embodiments of the present invention. The foregoing storage medium includes: any medium that can store program code, such as a USB flash drive, a removable hard disk, a read-only memory (Read-Only Memory, ROM for short), a random access memory (Random Access Memory, RAM for short), a magnetic disk, or an optical disc.

Finally, it should be noted that the foregoing embodiments are merely intended for describing the technical solutions of the present invention but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

1-10. (canceled)

11. A method for reducing interference between WiFi and LTE, comprising:
determining whether an LTE network is operating;
obtaining an operating status of the LTE network if the LTE network is operating, wherein the operating status of the LTE network comprises an operating frequency of the LTE network; and
determining a WiFi operating channel according to the operating status of the LTE network and a preset rule, wherein the preset rule comprises a correspondence between the operating status of the LTE network and a channel interference parameter between the LTE network and a WiFi channel.

12. The method according to claim 11, wherein when the channel interference parameter is a channel interference value, the determining a WiFi operating channel according to the operating status of the LTE network and a preset rule comprises:
determining one or more first WiFi channels according to the operating status of the LTE network and the preset rule, wherein each first WiFi channel is a WiFi channel that has a channel interference value less than a first threshold; and
selecting any unoccupied channel in the one or more first WiFi channels as the WiFi operating channel.

13. The method according to claim 11, wherein when the channel interference parameter is a throughput, the determining a WiFi operating channel according to the operating status of the LTE network and a preset rule comprises:
determining one or more second WiFi channels according to the operating status of the LTE network and the preset rule, wherein each second WiFi channel is a WiFi channel that has a throughput greater than or equal to a second threshold; and
selecting any unoccupied channel in the one or more second WiFi channels as the WiFi operating channel.

14. The method according to claim 11, wherein before the determining whether an LTE network is operating, the method further comprises: enabling a WiFi hotspot function.

15. The method according to claim 11, wherein the method further comprises: selecting any unoccupied channel in a set of one or more WiFi channels as the WiFi operating channel if the LTE network is not operating.

16. An apparatus for reducing interference between WiFi and LTE, comprising a memory and a processor, wherein the memory provides an instruction and data to the processor, and wherein the processor invokes the instructions stored in the memory to:
determine whether an LTE network is operating;
obtain an operating status of the LTE network if the LTE network is operating, wherein the operating status of the LTE network comprises an operating frequency of the LTE network; and
determine a WiFi operating channel according to the operating status of the LTE network and a preset rule, wherein the preset rule comprises a correspondence between the operating status of the LTE network and a channel interference parameter between the LTE network and a WiFi channel.

17. The apparatus according to claim 16, wherein when the channel interference parameter is a channel interference value the processor invokes the instructions stored in the memory to determine one or more first WiFi channels according to the operating status of the LTE network and the preset rule, wherein each first WiFi channel is a WiFi channel that has a channel interference value less than a first threshold; and
select any unoccupied channel in the one or more first WiFi channels as the WiFi operating channel.

18. The apparatus according to claim 16, wherein
when the channel interference parameter is a throughput the processor invokes the instructions stored in the memory to determine a second WiFi channel according to the operating status of the LTE network and the preset rule, wherein the second WiFi channel is a WiFi channel that has a throughput greater than or equal to a second threshold; and
select any unoccupied channel in the second WiFi channel as the WiFi operating channel.

19. The apparatus according to claim 17, wherein
when the channel interference parameter is a throughput the processor invokes the instructions stored in the memory to determine one or more second WiFi channels according to the operating status of the LTE network and the preset rule, wherein each second WiFi channel is a WiFi channel that has a throughput greater than or equal to a second threshold; and
select any unoccupied channel in the one or more second WiFi channels as the WiFi operating channel.

20. The apparatus according to claim 16, wherein the processor invokes the instructions stored in the memory to before determining whether the LTE network is operating, enable a WiFi hotspot function.

21. The apparatus according to claim 16, wherein the processor further invokes the instructions stored in the memory to select any unoccupied channel in a set of one or more WiFi channels as the WiFi operating channel if the LTE network is not operating.
